(19) United States
(12) Patent Application Publication
(10) Pub. No.: US 2013/0232675 A1
(43) Pub. Date: Sep. 12, 2013

(54) PROTECTIVE GARMENTS

(71) Applicants: Alison Syrett, Stadtbredimus (LU); Claude Michels, Luxembourg (LU); Serge Rebouillat, Echenevex (FR); Elke David Clos, Saarbruecken (DE)

(72) Inventors: Alison Syrett, Stadtbredimus (LU); Claude Michels, Luxembourg (LU); Serge Rebouillat, Echenevex (FR); Elke David Clos, Saarbruecken (DE)

(73) Assignee: E I DU PONT DE NEMOURS AND COMPANY, Wilmington, DE (US)

(21) Appl. No.: 13/885,707

(22) PCT Filed: Nov. 7, 2011
(86) PCT No.: PCT/US2011/059551

§ 371 Date: May 16, 2013

Related U.S. Application Data
(60) Provisional application No. 61/414,103, filed on Nov. 16, 2010.
(60) Provisional application No. 61/418,989, filed on Dec. 2, 2010.

(51) Int. Cl. A62D 5/00

(52) U.S. Cl. CPC A62D 5/00
USPC 2/455

(57) ABSTRACT

The present invention relates to a garment and its use for the protection against the penetration of aerosols and splashes,

said garment comprising at least two portions of a fabric joined together by a stitched seam, said stitched seam comprising at least one yarn, wherein said yarn is a hydrophobic yarn and/or comprises at least one hydrophobic agent; as well as a manufacturing method of the aforementioned garment.

### FIELD OF THE INVENTION

The present invention relates to garments, particularly to single use chemical protective garments, with improved seams.

### BACKGROUND OF THE INVENTION

In the past years, the manufacturing industry has seen efforts to reduce the use of harmful or even toxic, substances in several industrial processes, as regulatory and environmental directives become ever more demanding. In many industrial applications, however, technical progress has not yet provided for processes that can do without the use of harmful substances. It is therefore of paramount importance that personnel involved in manufacturing, when exposed to harmful substances, is sufficiently well protected to avoid any unnecessary contact with hazardous material, and minimize the risk of exposure.

In order to offer sufficient protection, protective garments must fulfill stringent international and regional standards relative to the performance requirements for protective clothing for protection against the penetration of aerosols and splashes, such as for example ISO 16602¹, EN 14605:2005+A1², EN ISO 13982-1:2004³, and EN 13034:2005+A1⁴ (commonly referred to as “type 3, 4, 5 & 6 chemical protective clothing” respectively). ¹Protective clothing for protection against emicals-Classifications, labelling and performance requirements.²Protective Clothing against liquid chemicals—performance requirements for clothing with liquid-tight (Type 3) or spray-tight (Type 4) connections, including items providing protection to parts of the body only (Type PB(3) and PB(4))³Protective clothing for use against solid particulates—performance requirements for chemical protective clothing providing protection to the full body against airborne solid particulates (type 5 clothing)⁴Protective clothing against liquid chemicals—performance requirements for chemical protective clothing offering limited protective performance against liquid chemicals (Type 6 and Type PB (6) equipment)

A common way to protect against harmful substances, be it liquids, aerosols, particulates, fines, fibrils, fibres or gases, is to wear a protective garment that is impermeable to those substances. While several, highly effective materials useful in the manufacture of protective garments are known, all garments have a common weak point, which are the seams by which they are held together and assembled.

In particular, stitched seams represent a weak point in garments, because they connect two or more portions of fabric by stitches, and harmful substances that otherwise would not penetrate through the fabrics may migrate through the space between the stitches, through the stitching yarn and the needle hole, or by wicking through the stitch yarn. To improve the impermeability of stitched seams, it can be advantageous to tape over the stitched seams with a tape or ribbon of impermeable material, or to thermally weld the seams together.

While both overtaping and welding methods can yield seams that have an effective barrier, they are, however, economically discouraged, because of the significant manufacturing cost increase of the protective garment.

It is therefore desirable to provide garments, particularly protective garments, which offer sufficient protection against harmful substances, particularly harmful liquids, at reasonable cost, which do not require overtaping or other additional sealing techniques to be performed on the seams therein and which can also be used in coating and paint applications as well as other industrial applications where paint repelling and contaminating substances are to be eliminated.

### SUMMARY OF THE INVENTION

The present invention provides a garment, particularly a protective garment, comprising at least two portions of a fabric joined together by a stitched seam, said stitched seam comprising at least one yarn, wherein said yarn is a hydrophobic yarn and/or comprises at least one hydrophobic agent.

### DETAILED DESCRIPTION

The features and advantages of the present disclosure will be more readily understood, by those of ordinary skill in the art, from reading the following detailed description. It is to be appreciated that certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The term “seam”, as used herein refers to the join where two or more portions of fabric or other materials are held together with stitches.

The term “stitch”, as used herein refers to any suitable stitch, such as running stitch, cross stitch, back stitch, chain stitch, lockstitch, overlock stitch and coverstitch.

The terms “garment” and “protective garment”, as used herein refer, without limitations, to coats, lab coats, trousers, jackets, aprons, coveralls, as well as partial body single use and single use accessories such as hoods, boot or shoe covers, sleeves, gloves, and any other clothing that may be used to cover at least a part of the body.

The term “fabric”, as used herein refers to any flexible material consisting of a network of natural and/or synthetic fibers.

The term “nonwoven fabric” as used herein refers to any fabric comprising a structure of individual fibers that are positioned in an essentially random manner to form an essentially planar material without an identifiable pattern, as opposed to a knitted or woven fabric.

The term “woven fabric” as used herein refers to any fabric having a at least one warp yarn and at least one weft yarn and being formed by interlacing the at least one warp yarn and the at least one weft yarn according to a particular weaving pattern or any fabric having at least one yarn being knitted according to a knitting pattern.

The term “fiber” as used herein refers to staple fibers, stretch-broken fibers, as well as continuous filaments, both natural and/or synthetic, or combinations thereof.

The term “hydrophobic agent” as used herein refers to a substance that is not easily wetted by polar solvents such as water; like for example substances that exhibit a contact angle in excess of 90° when contacted with a polar solvent, the angle being measured by static contact angle goniometer using the static sessile drop method.

The term “lipophobic agent” as used herein refers to a substance that is not easily wetted or solubilized by non-polar solvents.

The present invention provides protective garments with improved seams, comprising at least two portions of a fabric joined together by a stitched seam, said stitched seam comprises at least one yarn, wherein said yarn is a hydrophobic yarn and/or comprises at least one hydrophobic agent.

A hydrophobic agent may not be exclusively a hydrophobic agent, but may as well have lipophobic properties at the same time.

The at least two portions of a fabric may originate from one and the same fabric or from at least two independent discrete fabrics.

In the case where the at least two portions of a fabric are at least two independent discrete fabrics, the at least two portions of a fabric can be chosen independently from woven fabrics or nonwoven fabrics, or combinations thereof.

The fabric can be single layered or multiple layered.

The fabric may further be modified. To add functionality to the protective garment, in particular when it is intended to protect the feet and hands, the fabric of the garment may extend over the feet and hands, or consist of a separate piece of fabric that may be connected, for example by sewing, to the hem or leg of the garment. In the case where the garment is intended to protect the feet and hands, the fabric may be coated with a continuous or patterned layer of an anti-slip composition such as for example a thermosetting or thermoplastic polymer to form a sole that reduces slippage on the floor or to form a padding that enhances finger grip.

Woven fabrics can be chosen among fabrics having a plain, basket, twill, satin and other complex weave including, but not limited to, unidirectional, quasi unidirectional, multi-axial weaves and three dimensional materials, alone or in combination; or knitted fabrics.

Knitted fabrics generally form the cuffs of a garment, both at the end of the sleeves as well as at the end of the leg or they may form the liner that connects a zipper element to the garment.

In a unidirectional fabric the yarns all run in the same direction. In a quasi-unidirectional fabric the yarns may be laid in more than one direction and some yarns are not totally flat. As used herein, “unidirectional” encompasses both unidirectional and quasi-unidirectional fabric, unless the context requires otherwise.

Nonwoven fabrics may be chosen among polymeric nonwoven fabrics that may be formed from a polymer selected from the group consisting of polyolefins such as for example polyethylene and polypropylene, polyesters, acetyl polyoxymethylene resin, polyamides and/or mixtures thereof.

The nonwoven fabric may further comprise an additional layer of a polymeric material coated or laminated to it. The additional layer of polymeric material can be present in the form of a moisture vapor permeable thin film having small pores or as one or more impermeable layers. These laminates are typically referred to in the textile art(s) as “microporous film laminates” or barrier fabrics respectively and are commercially available, for example, from E.I. du Pont de Nemours & Company under the trademarks Proshield® or Tychem® respectively.

The at least two portions of a fabric can be chosen independently from treated or untreated fabrics. Treated fabrics can be chosen from fabrics that have been treated with coloring agents such as for example pigments, UV absorbers, antistatic agents, antimicrobial agents, flame retardant compositions or intumescing agents, hydrophobic agents and/or other suitable compounds.

Preferably, the fabric to be used to form the garment of the present invention is a nonwoven fabric. More preferably, the nonwoven fabric is a polyolefinic flash-spun or spun-bonded nonwoven fabric that is formed, for example, from a polymer selected from the group consisting of polyethylene, polypropylene, and mixtures thereof. Most preferably, the nonwoven fabric is a polyethylene flash-spun nonwoven fabric. Flash-spun nonwoven fabrics are commercially available, for example, from E.I. du Pont de Nemours & Co under the trademark “Tyvek®”.

The stitched seam of the garment comprises at least one yarn, which comprises at least one hydrophobic agent. The yarn can be chosen from spun yarns, core spun yarns, drawn yarns, stretch-broken yarns, continuous filament yarns which may have been treated to increase their bulk. In the case a yarn has been treated to increase its bulk, such yarn is referred to as a “bulked yarn”. Preferably, the at least one yarn is a bulked yarn.

The at least one yarn can be chosen from yarns having, for example, a linear weight of at least 10 tex, preferably having a linear weight of from 10 tex to 100 tex, more preferably of from 18 tex to 80 tex. Most preferably, the at least one yarn can be chosen among yarns having a linear weight of from 18 tex to 40 tex.

The at least one yarn can be made of man-made fibers, natural fibers, and/or combinations thereof.

Examples of natural fibers are cellulosic ones such as cotton, linen ramie, rayon, and bamboo fibers; wool and/or combinations thereof.

In the case where the at least one yarn is made of a natural fiber, the natural fiber is preferably cotton or lyocell.

The at least one yarn can be made of man-made fibers which may be inorganic or organic fibers.

Suitable man-made inorganic fibers may be chosen among carbon, glass ceramic fibers, and/or combinations thereof. The at least one yarn can be made of man-made organic fibers of polyolefin, polyamide, to polyamide imide, polyarylene sulfide, polyimide, polysulphone, poly(p-phenylene-2,6-benzobisoxazole), polybenzimidazole, polyhydroquinone-diimidazopyridine, polyester, and/or blends thereof.

Suitable polyolefins can be chosen among fluorinated olefin homopolymers such as for example polytetrafluoroethylene, polyvinylidene fluoride, polyvinyl fluoride and olefin homopolymers such as polyethylene, ultra high molecular weight polyethylene, polypropylene, and polybutylene, or olefin copolymers such as for example ethylene copolymers such as ethylene(meth)acrylic acid copolymers, ethylene alpha olefin copolymers, ethylene vinyl acetate copolymers, ethylene vinyl fluoride copolymers and ethylene vinyl chloride copolymers.

Suitable polyamides can be chosen among aliphatic polyamides such as for example polyamide 6 (PA6), polyamide 66 (PA66), polyamide 612 (PA612), polyamide 10 (PA10), and semi-aromatic or aromatic polyamides such as meta-aramids, para-aramids or copolyamides thereof. Suitable polyesters can be chosen among aliphatic polyesters such as, for example, polyglycolic acid, polylactic acid, polycaprolactone, polyethylene adipate, polyhydroxyalkanoate and semiaromatic polyesters such as, for example, polyethylene terephthalate, polybutylene terephthalate, polytrimethylene terephthalate, polyethylene naphtalate.

In the case where the at least one yarn is made of a polyester, the polyester is preferably a semiaromatic polyester, such as for example polyethylene terephthalate.

Preferably the yarn is made of cotton, polyester, polyamide or polyolefin.

According to the present invention, the at least one yarn is a hydrophobic yarn and/or comprises at least one hydrophobic agent.

If the yarn is a hydrophobic yarn it is made, for example of a fluoropolymer. Preferably it is a fluorinated olefinic homo- or copolymer, for example polytetrafluoroethylene or a mixture thereof with partially fluorinated olefin such as polyvinylidene fluoride. If the yarn is a hydrophobic yarn it may, even if not preferred, additionally comprise a hydrophobic agent, for example a hydrophobic agent as described below.

If the yarn comprises at least one hydrophobic agent the hydrophobic agent may be present in the form of a coating applied onto it. The hydrophobic agent may be applied, for example, in form of an aqueous dispersion, solution or emulsion, for example in form of an aqueous dispersion, solution or emulsion for fiber or filament treatment. Micro and nano dispersions and emulsions and mixtures thereof are also suitable. Aqueous and organic solvent based medium can be used depending on the operating conditions and applications. The hydrophobic matter may be formed during the yarn processing/coating from adequately selected chemical species that form a hydrophobic matter.

The hydrophobic agent may also be present as spun-in agent that can be incorporated during fiber or filament production.

Examples of coating techniques known in the art are kiss roll coating, knife coating, metering coating, dipping coating, immersion coating, brush coating, spray coating and/or combinations thereof, optionally followed by a heat treatment to eliminate solvent/water excess and/or increase the abrasion surface properties as well as the fiber cohesion and its processing performance during sewing.

The at least one hydrophobic agent may be present from 0.1 weight percent to 10 weight percent, preferably from 0.1 weight percent to 5 weight percent, more preferably from 0.5 weight percent to 3 weight percent, based on the total weight of the yarn.

Hydrophobic agents useful in the present invention may be chosen among agents comprising fluorocompound based compositions, e.g. fluoromonomer, fluorooligomer or fluoropolymer based compositions, preferably fluoropolymer based compositions, silicone based compositions, polyurethane based compositions, hotmelt based compositions, ketene based compositions, paraffin based compositions, acrylic based compositions, epoxy based compositions, and/or combinations thereof. The ketene based compositions may be chosen among those comprising ketene dimers described in European patent EP05754768, which is hereby incorporated by reference.

The silicone based compositions may be chosen among those comprising organosilicon based compounds such as for example aliphatic or cyclic polysiloxanes polydimethylsiloxane or polydimethyldiphenylsiloxane generally found in silicon yarn oils or silane based compounds such as for example alkoxysilanes and aminosilanes.

In addition to being hydrophobic agents, organosilicon based compounds may have lipophobic properties as well.

Polyurethane solutions, dispersions or emulsions are also suitable hydrophobic agents in the present invention.

The polyurethane based compositions may be chosen among those comprising a polyurethane formed by the reaction of a polyisocyanate (for example a diisocyanate) and a polyol (for example a diol). Examples of polyisocyanates, which may be used, include aromatic polyisocyanates, such as phenylene diisocyanate, toluene diisocyanate (e.g. 2,4- and 2,6-), tetramethylxylenediisocyanate, xylenediisocyanate, methylenediphenyl diisocyanate (MDI), as well as aliphatic and cycloaliphatic polyisocyanates, such as dicyclohexylmethane-4,4′-diisocyanate, hexamethylene diisocyanate, tetramethylenediisocyanate, trimethylhexamethylenediisocyanate, isophorone diisocyanate, and mixtures of any of these. Oligomeric isocyanates (such as polymeric MDI) may also be used. Also suitable are “prepolymers” of these polyisocyanates comprising a partially pre-reacted mixture of a polyisocyanate and a polyether or polyester polyol. Typically, the above polyisocyanates are used in an amount relative to the polyol to establish an isocyanate index in the range of 80 to 400.

The polyol may be either a polyol, a hydroxyfunctional polyether, or a hydroxyfunctional polyester, having preferably from 2 to 25 carbon atoms. Examples include ethane diol, propane diol, butane diol, pentane diol, hexane diol, decane diol, diethylene glycol, 2,2,4-trimethylpentane diol, 2,2-dimethylpropane diol, dimethylcyclohexane diol, 2,2-bis(4-hydroxyphenyl)-propan (Bisphenol A), 2,2-bis(4-hydroxyphenyl)butane (Bisphenol B), 1,1-bis(4-hydroxyphenyl)-3,3,5-trimethylcyclohexane (Bisphenol C), aromatic polyesterpolyols, polycaprolactone, poly(ethylene oxide), and poly(propylene oxide) polymers and copolymers with terminal hydroxyl groups derived from polyhydric compounds, for example diols and/or trials. Such diols and trials include, as non-limiting examples, ethylene glycol, propylene glycol, 1,3-butanediol, 1,4-butanediol, 1,6-hexanediol, neopentyl glycol, diethylene glycol, dipropylene glycol, pentaerythritol, glycerol, diglycerol, trimethylol propane, sugars such as sucrose, and other law molecular weight polyols. Also useful are amine polyether polyols which can be prepared by reacting an amine, such as ethylenediamine, diethylenetriamine, tolylenediamine, diphenylmethanediamine, triethanolamine or the like, with ethylene oxide or propylene oxide.

Advantageously, the polyurethanes of the polyurethane based compositions for the at least one yarn have the following components: 20-60 wt % of at least one isocyanate; 5-50 wt % of at least one polyetherdiol; 0-10 wt % of one or more aliphatic or cycloaliphatic diols; 0-50 wt %, preferably 5 to 50 wt % of one or more polyester diols; The preferred polyurethanes of the polyurethane based compositions are made with the monomers hexamethylenedi isocyanate (HMDI) and a polyesterpolyol having a linear or branched polyester component. The preferred polyurethane has a weight average molecular weight of 1,000-10,000 g/mol. Suitable polyurethanes are available commercially under the tradenames Alberdingk-PU® (Alberdingk), Impranil® (Bayer), and Permutex® (Stahl).

Polyurethane chains may have unreacted hydroxyends which can be cross-linked to form interchain bonds by adding additional polyisocyanate cross-linking agent. The hydrophobic polyurethane agents can be used by applying them to the surface of the at least one yarn and initiating interchain cross-linking, preferably using a cross-linking agent, and optionally a catalyst. Preferred cross-linking agents are the polyisocyanates mentioned above. Particularly preferably the polyisocyanate cross-linking agent is capped, for example with oxime groups. The capping group falls off at elevated temperatures (e.g. in the order of 140-200 C), initiating cross-linking. A preferred oxime capping group is butane oxime.

Preferably the cross-linking agent has more than two isocyanate groups, particularly preferably it has three isocyanate groups. The cross-linking agent is preferably present at or about 1 to 10 wt %, more preferably at or about 3 to 8 wt %, based on the total weight of the polyurethane based composition, minus the solvent.

The cross-linkable polyurethanes for use in the polyurethane based compositions may be selected from those that can be cross-linked under conditions that will not damage the at least one yarn. Cross-linking may be initiated with heat and/or by the use of a catalyst. If a catalyst is added, preferably it is added immediately prior to application of the hydrophobic agent to the at least one yarn. A cross-linking agent may be added to the polyurethane based compositions and the polyurethane based compositions stored at low temperature (i.e. below 200 C, more preferably below 4° C.), until application. After application of the polyurethane based compositions to the at least one yarn, the treated yarn is heated to initiate cross-linking. Alternatively, a cross-linking agent and/or catalyst may be added to the polyurethane based compositions immediately prior to application of the polyurethane based compositions to the at least one yarn.

The fluorocompound based compositions, in particular fluoropolymer based compositions may be chosen among those comprising fluoroaliphatic agents and their condensation polymers such as polyesters, polyamides or polyepoxides and their vinyl polymers such as polyacrylates, polymethacrylates or polyvinyl ethers.

Condensation polymers of the fluoroaliphatic agents may be chosen among those formed by the reaction of perfluoroaliphatic glycols or thioglycols with diisocyanates to provide perfluoroaliphatic group-bearing polyurethanes, fluoroaliphatic N-methylol condensation products, fluoroaliphatic polycarbodiimides obtained by the reaction of perfluoroaliphatic sulfonamido alkanols with polyisocyanates in the presence of suitable catalysts.

The fluoropolymer based compositions may further be copolymers of one or more fluoroaliphatic acrylate or methacrylate monomers, and one or more fluorine-free hydrocarbon ethylenically-unsaturated comonomer. Examples of fluoroaliphatic radical-containing acrylate or methacrylate monomers are acrylate or methacrylate perfluoroalkyl monomers.

Preferred fluorine-free hydrocarbon ethylenically-unsaturated comonomers which can be copolymerized with the above-described fluoroaliphatic radical-containing acrylate or methacrylate monomers include those selected from the group consisting of octadecylmethacryate, 1,4-butanediol diacrylate, laurylmethacrylate, butylacrylate. N-methylol acrylamide, isobutylmethacrylate, ethylhexyl acrylate, ethylhexyl methacrylate, vinylchloride and vinylidene chloride.

In addition to being hydrophobic agents, fluoropolymer based compounds can have lipophobic properties as well, depending for example on the alkyl chain length selection.

The fluoropolymer based compositions may be applied neat or diluted for example in water or an aqueous medium, using methods known in the art such as for example kiss roll application. The lower part of the kiss roll dips in the finish bath, while the yarn tangentially moves over the top part. The add-on level of fluoropolymer based compositions can be varied by changing several parameters, such as the geometry between yarn and roll, roll speed and the concentration of fluoropolymer based compositions in the bath.

Preferably, the hydrophobic agents may be chosen among agents comprising fluoropolymer based compositions, polyurethane based compositions, ketene based compositions, paraffin based compositions, acrylic based compositions, epoxy based compositions, and/or combinations thereof.

More preferably, the hydrophobic agents may be chosen among agents comprising fluoropolymer based compositions, polyurethane based compositions, ketene based compositions, paraffin based compositions, acrylic based compositions, epoxy based compositions, and/or combinations thereof and are essentially free of or do not comprise organosilicon based compounds like polysiloxanes such as polydimethylsiloxane or polydimethyldiphenylsiloxane generally found in silicon yarn oils; or silane based compounds such as for example alkoxysilanes and aminosilanes. Organosilicon based compounds are contaminants in paint, lacquer and coating applications, even if present only in very small concentrations, which can lead to surface defects, e.g. to defects known as craters or fisheyes, on the coated, lacquered or painted surface. The hydrophobic agents according to the above embodiment are also essentially free of or do not comprise other paint repellent substances.

Although organosilicon containing compounds are to be avoided, it may be possible to use a core spun yarn whose core comprises an organosilicon compound in the present invention as long as said core is sealed away from contact to the exterior by an outer yarn, which outer yarn may additionally have an organosilicon barrier treatment applied to it.

The hydrophobic agent may be formed during processing of the yarn or after sewing thanks to a post treatment such as UV/IR curing.

Most preferably the at least one hydrophobic agent is a fluorocompound based composition, specifically a fluoropolymer based composition.

The garment of the present invention comprises at least one stitched seam stitched with the at least one yarn. Suitable stitches may be chosen among running stitch, cross stitch, back stitch, chain stitch, lockstitch, overlock stitch, coverstitch and single stitch. Preferably, the stitches may be chosen from overlock stitch and lockstitch.

The at least one seam can be present as an external and/or internal seam. Preferably, the at least one seam can be present as an internal seam.

According to a further preferred embodiment the fabric is a nonwoven fabric, preferably an olefinic nonwoven fabric and the yarn comprises at least one fluorocompound containing composition, preferably at least one fluoropolymer containing composition,

In a further aspect, the present invention provides a process for manufacturing a garment, particularly a protective garment, comprising the steps: (A) bringing at least two portions of a fabric into proximity, (B) joining the at least two portions of the fabric by stitching with a yarn, thereby forming a stitched seam, wherein the yarn is a hydrophobic yarn and/or comprises at least one hydrophobic agent.

The sewing needles useful in the present process may be chosen among needles having a gauge of from 55 NM (“Number Metric”) to 120 NM.

In the case where the fabric of the process is a polyolefinic flash-spun or spun-bonded nonwoven fabric, the sewing needle may be chosen among needles having a gauge of from 65 NM to 75 NM.

Using a yarn that is a hydrophobic yarn and/or comprises at least one hydrophobic agent allows different seam techniques and suit designs to be used that optimize garment production cost and maximize protective performance such as to pass required liquid & water penetration tests (for example, the EN ISO 17491-4:2008 Methods A and B standard).

In the preferred embodiment, where the hydrophobic agent does not comprise organosilicon based compounds and other paint repellent substances, the protective garment of the present offers the further advantage of being able to be used in sensitive industrial areas like the paint industry without the risk of contaminating coating compositions with paint wetting disrupting substances.

In another aspect, the invention provides for the use of a garment, in particular a protective garment, for protection against the penetration of aerosols and splashes, the garment comprising at least two portions of a fabric joined together by a stitched seam, said stitched seam comprising at least one yarn, wherein said yarn is a hydrophobic yarn and/or comprises at least one hydrophobic agent.

Aerosols are suspensions of particles in a gas, which particles may be either solid or liquid.

Solid particles may be inorganic or organic chemical substances, or mixtures thereof, useful in manufacturing processes.

Liquid particles may be any liquid chemical substances useful in manufacturing processes.

Splashes in the context of the present invention are splashes of liquids such as for example pure liquids, emulsions, dispersions, colloidal solutions.

In particular, the use of a garment according to the present invention seeks to offer protection against the penetration of aerosols and splashes of substances having temporary or permanent adverse effects on human health such volatile organic compounds, acidic or caustic substances, poisons and such.

The protective garment may further comprise an air supply coupling for coupling the protective garment to an external respiratory gas supply or a pressurized gas.

The present invention is further defined in the following Examples. It should be understood that these Examples, while indicating preferred embodiments of the invention, are given by way of illustration only.

### Examples

A coverall garment made of flash spun fabric, commercially available to under the trademark Tyvek® 1422A from E. I. du Pont de Nemours and Company (Wilmington Del., USA) was tested under standard EN ISO 174914:2008 for compliancy with EN ISO 174914: Method A and EN ISO 17491-4: Method B requirements.

The seams joining the different parts of the coverall garment were made using a three & five thread overlock stitch, and the yarn used was a 19 tex polyethylene terephthalate bulked yarn treated with a fluorocompound based composition'. The sewing needle was a 70 NM needle.

The thus obtained garment was then worn over a detector garment and then subjected to a test according to EN ISO 174914:2008 Method A and a test according to EN ISO 17491-4:2008 Method B. Each test was made in triplicate.

For EN ISO 174914: Method B, a person wearing the detector garment under the coverall garment was sprayed with colored water having a surface tension of 30±5×10⁻³ N/m exiting from 4 nozzles positioned at leg, waist, torso, and shoulder height for one minute, each nozzle set at a flowrate of 1.14±0.1 l/min. After this, the coverall garment was removed and the underlying detector garment was inspected for stains caused by any colored water that had penetrated into the interior of the coverall garment.

The test was deemed to be passed if the combined area of the stains on the detector garment due to the colored water was less than three times the area of a calibration stain caused by 25±5 μl colored water as specified in ISO 17491:4. Results are shown in Table 1.

For EN ISO 17491-4: Method A, a person wearing the detector garment under the coverall garment was sprayed with colored water having a surface tension of 52±7.5×10⁻³ N/m exiting from 4 nozzles positioned at leg, waist, torso, and shoulder height for one minute, each nozzle set at a flowrate of 0.47±0.05/min.

After this, the coverall garment was removed and the underlying detector garment was inspected for stains caused by any colored water that had penetrated into the interior of the coverall garment.

The test was deemed to be passed if the combined area of the stains on the detector garment due to the colored water was less than three times the area of a calibration stain caused by 25±5 μl colored water as specified in ISO 17491:4. Results are shown in Table 1.

TABLE 1

| | EN ISO 17491-4:2008 | EN ISO 17491-4: 2008 |
|---|---|---|
| | Method A | Method B |
| | (“low level spray test”) | (“high level spray test”) |
| Test 1 | pass | Pass |
| Test 2 | pass | Pass |
| Test 3 | pass | Pass |

Table 1 shows the results for the test according to EN ISO 17491-4:2008 Method A & Method B.

As can be seen from the results in Table 1, the coverall garment according to the present invention having seams made with a yarn comprising a fluorocompound based composition pass the EN ISO 17491-4 method A as well as the more stringent method B requirements.

A comparative coverall garment made of flash spun fabric, commercially available under the trademark Tyvek® 1422A from E. I. du Pont de Nemours and Company (Wilmington Del., USA) was tested under standard EN ISO 17491-4: Method A requirements.

The seams joining the different parts of the coverall garment were made using a three & five thread overlock stitch, and the yarn used was a 19 tex polyethylene terephthalate untreated, bulked yarn free of a fluorocompound based composition. The sewing needle was a 70 NM needle.

The thus obtained garment was then worn over a detector garment and then subjected to a test according to EN ISO 174914:2008 Method B, as described above. The comparative test was made in triplicate and results are shown in Table 2.

TABLE 2

| | EN ISO 17491-4:2008 | EN ISO 17491-4: 2008 |
|---|---|---|
| | Method A | Method B |
| | (“low level spray test”) | (“high level spray test”) |
| Comparative test 1 | fail | n.a |
| Comparative test 2 | fail | n.a |
| Comparative test 3 | fail | n.a |

Table 2 shows the results for the test according to EN ISO 17491-4:2008 Method A.

As can be seen from the results in Table 2, a coverall garment having seams made with an untreated yarn lacking a fluorocompound based composition will not pass the EN ISO 17491-4 method A. A test according to the more stringent method B was not performed, as it is believed that the comparative garment would certainly fail this test in view of the results obtained in the less stringent EN ISO 17491-4: Method A test.

### Crater Test

5 grams of 19 tex polyethylene terephthalate bulked yarn treated with a fluorocompound based composition were introduced into 150 ml of an extraction liquid comprising a mixture of butyl glycol and n-propanol (Mixture 8D60-00067) for 48 hours at 20° C. in order to extract the fluorocompound based composition.

The extraction liquid was then decanted and filtered through a 10 μm filter and 75 ml of the extraction liquid were incorporated into a 935 ml of a lacquer half composition consisting of 700 ml of water and 225 ml to Surfynol® 104.

65 g of the lacquer half composition were then mixed with 80 g of a half composition consisting of 12.5 wt % Shellsol®, 50 wt % butyldiglycol and 37.5 wt % n-methylpyrrolidone, and with 855 g Resydrol® to yield the finished lacquer composition.

The lacquer composition was the applied to four square plates having dimensions 50 cm×50 cm which were spray coated by hand with two 10 μm layers of lacquer composition.

The coated square plates were then visually checked for imperfections and crater formation. None of the four square plates presented defects visible to the naked eye, and the test was deemed to be passed.

The test was performed according to an internal test method WU-I-1174-AQT.

*The polyethylene terephthalate yarn treated with a fluorocompound based composition is commercially available under the trademark Sabatex® 120 SNA+WR from Amann & Söhne GmbH & Co. KG (Bönnigheim, DE).

1. A garment comprising at least two portions of a fabric joined together by a stitched seam, said stitched seam comprising at least one yarn, wherein said yarn is a hydrophobic yarn and/or comprises at least one hydrophobic agent.

2. The garment according to claim 1, wherein the hydrophobic agent comprises fluorocompound based compositions, silicone based compositions, polyurethane based compositions, hotmelt based compositions, ketene based compositions, paraffin based compositions, acrylic and methacrylic based compositions, epoxy based compositions, and/or combinations thereof.

3. The garment according to claim 1, wherein the hydrophobic agent comprises fluoropolymer based compositions, polyurethane based compositions, ketene based compositions, paraffin based compositions, acrylic and methacrylic based compositions, epoxy based compositions, and/or combinations thereof.

4. The garment according to claim 1, wherein the hydrophobic agent comprises fluoropolymer based compositions.

5. The garment according to claim 1, wherein the yarn is a hydrophobic yarn made of at least one fluorinated olefinic homo- or copolymer.

6. The garment according to claim 5, wherein the at least one fluorinated olefinic homo- or copolymer is polytetrafluoroethylene (PTFE).

7. The garment according to claim 1, wherein the yarn is made of cotton, polyester, polyamide or polyolefin.

8. The garment according to claim 1, wherein the fabric is a nonwoven fabric.

9. The garment according to claim 8, wherein the nonwoven fabric is a polyolefinic flash-spun or spun-bonded nonwoven fabric.

10. The garment according to claim 1, wherein the yarn is made of polyester and wherein the hydrophobic agent comprises fluoropolymer based compositions.

11. The garment according to claim 1, wherein the fabric further comprises an additional layer of a polymeric material.

12. The garment according to claim 1, wherein the yarn is essentially free of organosilicon based compounds.

13. A process for manufacturing a garment of claim 1, comprising the steps:
(A) bringing at least two portions of a fabric into proximity, and
(B) joining the at least two portions of the fabric by stitching with a yarn, thereby forming a stitched seam, wherein the yarn is a hydrophobic yarn and/or comprises at least one hydrophobic agent.

14. (canceled)
